(19) United States
(12) Patent Application Publication
(10) Pub. No.: US 2009/0160336 A1
(43) Pub. Date: Jun. 25, 2009

(54) PLASMA DISPLAY PANEL

(76) Inventors: Koji Ohira, Miyazaki (JP); Masahiro Sawa, Miyazaki (JP)

Correspondence Address: STAAS & HALSEY LLP, SUITE 700, 1201 NEW YORK AVENUE, N.W., WASHINGTON, DC, 20005, US

(21) Appl. No.: 12/295,970

(22) PCT Filed: May 1, 2006
(86) PCT No.: PCT/JP2006/309109

§ 371 Date: Oct. 3, 2008

(51) Int. Cl. H01J 17/49

(52) U.S. Cl. 313/584

(57) ABSTRACT

A high-definition, high-reliability plasma display panel having a simple structure and having a stably ensured gas-exhaust passage. In the plasma display panel, display electrodes and address electrodes crossing these display electrodes are provided between a pair of substrate defining an electric discharge space, display lines produced by surface discharge are provided between adjacent display electrodes, discharge luminous regions are provided at cross sections between display lines and address electrodes, partitions (29) for defining discharge luminous regions for each line and for each column by first wall sections (29a) extending in the line direction in which the display electrodes are provided and second wall sections (29b) extending in the column direction in which the address electrodes are provided, nondischarge regions (31) are formed at interlinear sections which are sections between adjacent display lines, auxiliary partitions (32) projecting the first or second wall sections (29a or 29b) of the partitions (29) defining the nondischarge region (31) are formed by baking a material having a thermal shrinkability. Since the thermal shrinkage by the baking in the height direction is uneven, the height of the top part is partially greater than those of the top parts of the first and second partitions (29a, 29b) of the partitions defining the nondischarge regions (31).

### TECHNICAL FIELD

This invention relates to a plasma display panel (PDP), and more particularly relates to a PDP that has partitions for defining discharge light-emission regions for each line and for each column.

### BACKGROUND ART

At present, PDPs of an AC-drive type that are generally commercialized are those of a surface-discharge type. Herein, “surface-discharge type” refers to a type of structure in which first and second display electrodes, which respectively form cathodes and anodes so as to perform a display discharge as a main discharge, are arranged on a substrate on a front face side or a back face side respectively in parallel with each other.

In a surface-discharge-type PDP, phosphor layers used for color display can be disposed apart from paired display electrodes in a panel thickness direction, and with this arrangement, it is possible to reduce degradation of the phosphor layers due to ion impact at the time of discharging. Therefore, in comparison with a counter-discharge-type in which first and second display electrodes are respectively disposed on a frontside substrate and a backside substrate in a separate manner, the surface-discharge-type PDP is suitable for achieving a long service life.

A typical electrode matrix structure of the surface-discharge type is “three-electrode structure”. As one example of this three-electrode structure, a structure has been proposed in which a large number of display electrodes capable of surface discharging are formed in a horizontal direction (line direction) on an inner face of one of substrates (for example, a frontside substrate) and a large number of address electrodes for use in selecting light-emitting cells are placed in an intersecting direction (column direction) with the display electrodes on an inner face of the other substrate (for example, a backside substrate) so that each of intersections between the display electrodes and the address electrodes is allowed to form one cell (unit light-emitting region).

Here, one pixel is configured by three cells, that is, a red (R) cell, a green (G) cell and a blue (B) cell. Moreover, after the frontside substrate and backside substrate thus formed have been aligned face to face with other, with peripheral portions being sealed, a discharge gas is sealed inside thereof so that a PDP is manufactured.

A basic mode of the above-mentioned example relating to the three-electrode structure has a structure in which one pair of display electrodes are disposed on each line on the screen. A layout distance (surface-discharge gap length) between the paired display electrodes on each line is set in a range from several tens of μms to one hundred and several tens of μms. By using this surface-discharge gap length, a discharge with a voltage of about 200 to 250 volts is generated. In contrast, an electrode distance (reverse slit) between adjacent lines is set to a value sufficiently greater than the surface-discharge gap length in order to prevent a surface discharge from occurring therein. In this case, since a reverse slit side forms a non-light-emission region, this side forms a loss portion in terms of screen utilization.

As another example of the three-electrode structure, a structure has been proposed in which display electrodes are arranged with equal intervals, and a surface discharge is generated by using mutual adjacent display electrodes as paired electrodes. In this structure, since a slit width and a reverse slit width are the same, it becomes difficult to carry out a driving operation by using the same driving method as a method for a structure with a wide reverse slit side. For this reason, a method has been proposed in which, by using an interlace system which allows an odd line (odd-numbered line) and an even line (even-numbered line) to alternately discharge for each single field, a displaying process is carried out so that even a discharge for one line allows a resulting light emission to reach the reverse slit (see Japanese Unexamined Patent Publication No. 9-160525 and Japanese Unexamined Patent Publication No. 2000-113828).

In accordance with this method, since the reverse slit side also forms a light-emission region, a utilization rate of light emission can be improved so that a PDP having high luminance and high efficiency can be achieved. In this method, however, since a complicated driving sequence for addressing so as to set display contents is required, and since no reverse slit is present, with the display electrodes being associated with two adjacent lines in a longitudinal direction, a discharge interference tends to occur between adjacent display cells.

A structure, shown in FIGS. 10 and 11, has been known as the structure for enhancing the utilization rate of the screen in the three-electrode structure and for preventing discharge interference in display cells that are adjacent in the longitudinal direction. That is, in this structure, partitions 29 are formed on a second substrate (backside substrate) in parallel with a line direction (lateral direction), and the partitions are superposed on elongated feeder conductive films (BUS electrode 13) that are formed on display electrodes X and Y of a first substrate (frontside substrate) with equal intervals, and continuously extend along an overall length in the line direction. This structure provides a unit discharge light-emission region 30 (one cell) that forms a closed space surrounded by lateral wall sections 29a and longitudinal wall sections 29b of the partitions 29 from four sides (see Japanese Unexamined Patent Publication No. 2002-83545).

In a case of this structure, a phosphor area relating to light emission per cell is enlarged, and light-emission efficiency increases by about 1.2 times. The reason for this is because a cell structure with the lateral wall section 29a formed on the BUS electrode 13 has no light shielded by the BUS electrode 13 on the discharge light-emission region 30 so that the phosphor light emission can be utilized efficiently.

Here, these effects are obtained on a premise that a width of the lateral wall section 29a is made larger than a width of the BUS electrode 13 and that a positioning process between the BUS electrode 13 and the lateral wall section 29a (positioning process between the frontside substrate and the backside substrate) is carried out with considerably high precision. In an actual structure, by taking into consideration deviations in this positioning process, the width of the lateral wall section 29a is made larger than the width of the BUS electrode 13 by several tens of μms. Moreover, a charge transfer in a longitudinal direction is physically interrupted by the lateral wall sections 29a so that it is possible to prevent discharge interference toward a neighboring side in the longitudinal direction.

Additionally, Japanese Unexamined Patent Publication No. 2003-5699 has disclosed a driving sequence that achieves a display of a progressive system by utilizing an advantage that no discharge interference occurs in the longitudinal direction.

### DISCLOSURE OF THE INVENTION

### Problems to be Solved by the Invention

In general, in a PDP, exhaust efficiency in an exhaust process after a sealing process of a panel gives great influences to an electrical characteristic of the panel. When removal of impurities from an inside of the panel by the exhausting process is insufficient, a reduction in luminance and fluctuations in voltage due to degradation of a phosphor or irregularities on a panel inplane due to fluctuations in voltage tend to occur.

In particular, in a panel center portion, an exhaust conductance becomes smaller than that in a peripheral portion to cause difficulty in exhausting impurities. For this reason, it is considered that in years to come, the exhaust of impurities becomes more difficult along with developments of large-size panels and high-precision panels.

Moreover, in a case of a PDP having a closed-type partition structure that achieves high light-emission efficiency, an exhaust conductance becomes smaller as a matter of course in comparison with a PDP having a stripe-shaped partition structure, normally making it difficult to ensure a sufficient exhaust passage. For this reason, it is indispensably required to increase the exhaust conductance to raise the exhaust efficiency so as to achieve a high-quality PDP with high precision.

Conventionally, as described in Japanese Unexamined Patent Publication No. 2002-83545, in an attempt to increase the exhaust efficiency, a height of a lateral wall section including an intersection point of partitions is made lower by utilizing thermal shrinkage. However, depending on materials used for partitions, it is difficult to provide a height difference in partitions, and it sometimes becomes difficult to form a sufficient exhaust passage.

The present invention has been devised in view of these circumstances, and its object is to provide a high-quality plasma display panel with high reliability that has a simple structure, and stably ensures an exhaust passage.

### Means for Solving the Problems

The present invention relates to a plasma display panel that is provided with: a pair of substrates for forming a discharge space; a plurality of display electrodes that extend in a predetermined direction and a plurality of address electrodes that extend in a direction intersecting with the display electrodes, with the display electrodes and the address electrodes being placed between the paired substrates; display lines produced by surface discharge that are provided between the display electrodes adjacent to each other, with a discharge light-emission region being set at an intersection between each display line and each address electrode; and partitions for defining the discharge light-emission regions for each line and for each column, by a first wall section that extends in a direction along which the display electrodes are formed and a second wall section that extends in a direction along which the address electrodes are formed, and the plasma display panel is characterized in that a non-discharge region is formed between the display lines adjacent to each other, and an auxiliary partition is formed on the first wall section or the second wall section of the partitions that divide the non-discharge region so as to protrude into the non-discharge region therefrom, with the auxiliary partition being formed by firing a material having a thermal shrinkability, so that upon firing, since an amount of thermal shrinkage in a height direction becomes uneven, a height of an upper face of the auxiliary partition is partially made higher than the height of the upper face of the first wall section and the height of the upper face of the second wall section of each of the partitions that divide the non-discharge region.

### EFFECTS OF THE INVENTION

In accordance with the present invention, since an upper face of an auxiliary partition is partially made higher than a height of the upper face of a first wall section or the upper face of a second wall section of each of the partitions that divide a non-discharge region, it is possible to stably ensure a gas exhaust passage with a simple structure, and consequently provide a high-quality plasma display panel with high reliability.

In the present invention, paired substrates (for example, a frontside substrate and a backside substrate) include substrates made of glass, quartz and ceramics, and substrates with desired constituent elements, such as an electrode, an insulating film, a dielectric layer and a protective film, formed on these substrates.

A plurality of display electrodes may include any display electrodes formed on one of substrates (for example, the frontside substrate) so as to extend in a predetermined direction. Moreover, a plurality of address electrodes may include any address electrodes formed on the other substrate (for example, the backside substrate) so as to extend in a direction intersecting with the display electrodes on one of the substrates.

The display electrodes and the address electrodes may be formed by using any kinds of materials and methods conventionally known in a corresponding field. Examples of materials used for these electrodes include transparent conductive materials, such as ITO and SnO₂, and metal conductive materials, such as Ag, Au, Al, Cu, and Cr. Various kinds of methods known in the corresponding field may be applied to a method for forming the electrodes. For example, a thick-film-forming technique such as a screen-printing process may be used, and a thin-film-forming technique including a physical deposition method, such as a vapor deposition method and a sputtering method, or a chemical deposition method such as a thermal CVD method and a photo CVD method, may be used.

### BRIEF DESCRIPTION OF THE DRAWINGS

FIG. 1 is an explanatory drawing showing a structure of a PDP of the present invention.

FIG. 2 is a plan view showing partitions and auxiliary partitions in accordance with a first embodiment of the PDP of the present invention.

FIG. 3 is a plan view showing a positional relationship between the partitions and display electrodes in accordance with the first embodiment.

FIG. 4 is a perspective view showing a three-dimensional structure of the partitions and the auxiliary ribs in accordance with the first embodiment.

FIG. 5 is a plan view showing partitions and auxiliary partitions in accordance with a second embodiment of the PDP of the present invention.

FIG. 6 is a plan view showing partitions and auxiliary partitions in accordance with a third embodiment of the PDP of the present invention.

FIG. 7 is a plan view showing partitions and auxiliary partitions in accordance with a fourth embodiment of the PDP of the present invention.

FIG. 8 is a plan view showing partitions and auxiliary partitions in accordance with a fifth embodiment of the PDP of the present invention.

FIG. 9 is a plan view showing partitions and auxiliary partitions in accordance with a sixth embodiment of the PDP of the present invention.

FIG. 10 is a plan view showing partitions of a conventional PDP.

FIG. 11 is a plan view showing a positional relationship between the partitions and display electrodes in the conventional PDP of FIG. 10.

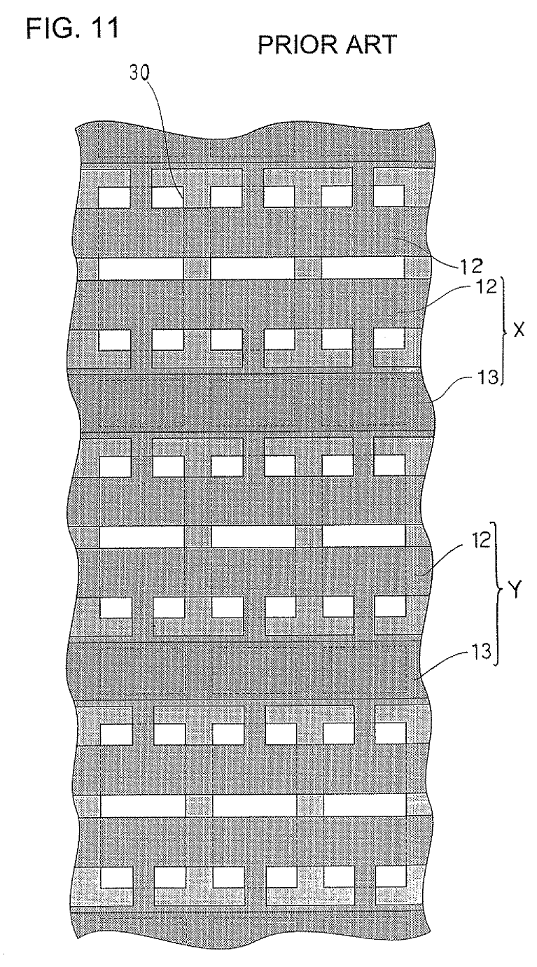

FIG. 12 is a schematic drawing showing thermal shrinkage upon forming partitions.

### DESCRIPTION OF REFERENCE SYMBOLS

10 PDP
11 substrate on front face side
12 transparent electrode
13 BUS electrode
17 dielectric layer
19 protective film
21 substrate on back face side
24 dielectric layer
28R phosphor layer
28G phosphor layer
28B phosphor layer
29 partition
29a lateral wall section (first wall section)
29b longitudinal wall section (second wall section)
30 discharge light-emitting region (discharge space)
31 non-discharge region
32 auxiliary partition
33 auxiliary partition
34 auxiliary partition auxiliary partition
36 auxiliary partition
37 auxiliary partition
A address electrode
L display line
X display electrode
Y display electrode

### BEST MODE FOR CARRYING OUT THE INVENTION

Hereinafter, the present invention will be described in detail with reference to embodiments shown in drawings. It should be noted that the present invention is not intended to be limited by these embodiments, and various modifications may be made therein.

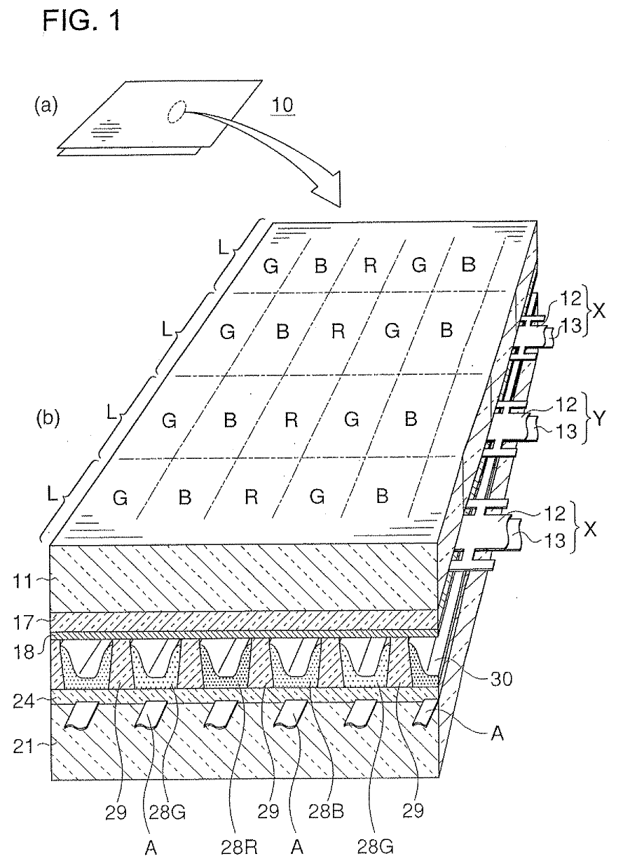

FIGS. 1(a) and 1(b) are explanatory views that show a structure of a PDP of the present invention. FIG. 1(a) is a general view, and FIG. 1(b) is a partially exploded perspective view. This PDP is a three-electrode surface-discharge-type PDP of an AC-drive type for color display.

A PDP 10 is configured by a substrate 11 on a front face side and a substrate 21 on a back face side. As the substrate 11 and the substrate 21, for example, glass substrates, quartz substrates, ceramic substrates or the like may be used.

On an inner side face of the substrate 11 on the front face side, display electrodes X and display electrodes Y that extend in a horizontal direction are disposed with equal intervals. That is, the paired display electrodes X and Y are disposed, with a space region (non-discharge region) where no discharge is generated being interposed therebetween. All gaps between the adjacent display electrodes X and display electrodes Y form display lines L.

Each of the display electrodes X and Y is configured by a transparent electrode 12 having a wide width, made of ITO, SnO₂ or the like, and a BUS electrode 13 having a narrow width, made of, for example, Ag, Au, Al, Cu, and Cr, as well as a laminated body (for example, Cr/Cu/Cr laminated structure) or the like thereof. Upon forming these display electrodes X and Y, a thick-film-forming technique such as a screen-printing process is used for Ag and Au, and a thin-film-forming technique, such as a vapor deposition method and a sputtering method, and an etching technique are used for other materials so that a desired number of electrodes having a desired thickness, width and gap can be formed.

On the display electrodes X and Y, a dielectric layer 17 is formed in a manner so as to cover the display electrodes X and Y. The dielectric layer 17 is formed by processes in which a low-melting-point glass paste is applied onto a substrate 11 on the front face side by using a screen-printing method and fired thereon. The dielectric layer 17 may be formed by forming a SiO₂ film with a plasma CVD method.

A protective film 18, used for protecting the dielectric film 17 from damage due to collision of ions generated by discharge upon displaying, is formed on the dielectric layer 17. This protective film 18 is made from MgO. The protective film 18 may be formed by using a known thin-film forming process in a corresponding field, such as an electron beam vapor deposition method and a sputtering method.

On the inner side face of a substrate 21 on the back face side, a plurality of address electrodes A are formed in a direction intersecting with the display electrodes X and Y on a plan view, and a dielectric layer 24 is formed in a manner so as to cover the address electrodes A. The address electrodes A, which generate an address discharge used for selecting cells to emit light at intersections with the display electrodes Y, is formed into a three-layer structure of Cr/Cu/Cr.

Moreover, these address electrodes A may also be formed by using other materials, such as Ag, Au, Al, Cu and Cr. In a same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for other metals so that a desired number of electrodes having desired thickness, width and gap can be formed. The dielectric layer 24 may be formed by using the same material and the same method as those of the dielectric layer 17.

A plurality of partitions 29 are formed on the dielectric layer 24 between the mutually adjacent address electrodes A. The partitions 29 have a mesh shape that divides a discharge space for each of the cells.

The partitions 29 may be formed through a method, such as a sand blasting method, a photoetching method, or the like. For example, in the sand blasting method, a glass paste, made from a low-melting-point glass frit, a binder resin, a solvent and the like, is applied onto a dielectric layer 24, and after this has been dried thereon, grinding particles are blasted onto a resulting glass paste layer, with a grinding mask having apertures of a partition pattern being placed thereon, so that the glass paste layer exposed to the mask apertures is ground, and a resulting substrate is then fired; thus, partitions are formed. Moreover, in the photoetching method, in place of grinding by using the grinding particles, a photosensitive resin is used as the binder resin, and after exposing and developing processes with use of a mask, the resulting substrate is fired so that partitions are formed.

On side faces and a bottom face of a discharge space surrounded by the partitions 29, phosphor layers 28R, 28G and 28B corresponding to red (R), green (G) and blue (B) are formed. The phosphor layers 28R, 28G and 28B are formed through processes in which a phosphor paste containing phosphor powder, a binder resin and a solvent is applied onto an inside of the discharge space surrounded by the partitions 29 by using a screen-printing method or a method using a dispenser, and after these processes have been repeated for each color, a firing process is carried out thereon.

These phosphor layers 28R, 28G and 28B may also be formed by using a photolithographic technique in which a sheet-shaped phosphor layer material (so-called green sheet) containing phosphor powder, a photosensitive material and a binder resin is used. In this case, a sheet having a desired color may be affixed onto an entire face of a display region on a substrate, and the sheet is subjected to exposing and developing processes; thus, by repeating these processes for each of the colors, the phosphor layers having the respective colors are formed in the corresponding gaps between the partitions.

The PDP is manufactured through processes in which the substrate 11 on the front face side and the substrate 21 on the back face side are aligned face to face with each other in a manner so as to allow the display electrodes X, Y and address electrodes A to intersect with each other, and the peripheral portion thereof is sealed, with a discharge space 30 surrounded by partitions 29 being filled with a discharge gas formed by mixing Xe and Ne. In this PDP, the discharge space 30 at each of intersections between the display electrodes X, Y and the address electrodes A forms one cell (unit light-emitting region) that is a minimum unit of display. One pixel is configured by three cells of R, B and G.

### FIRST EMBODIMENT

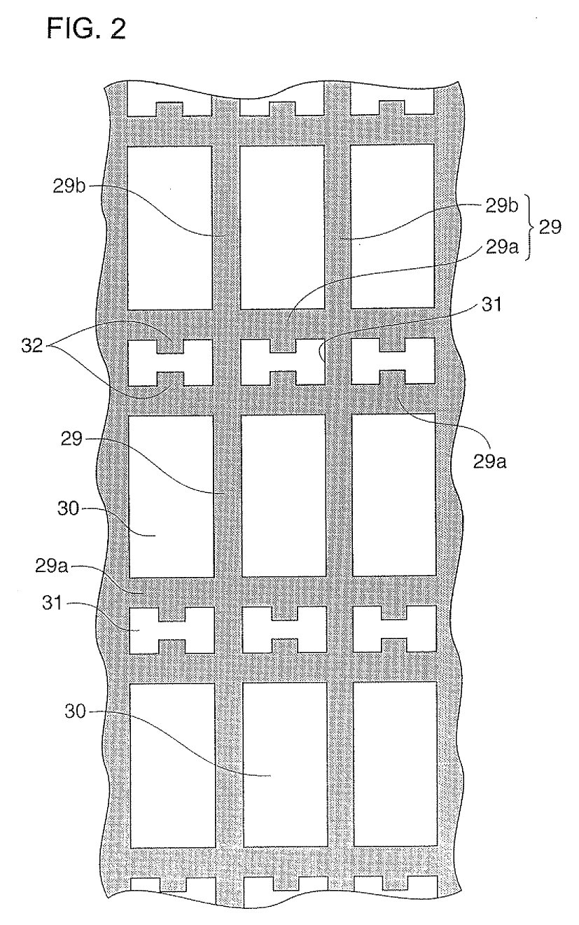

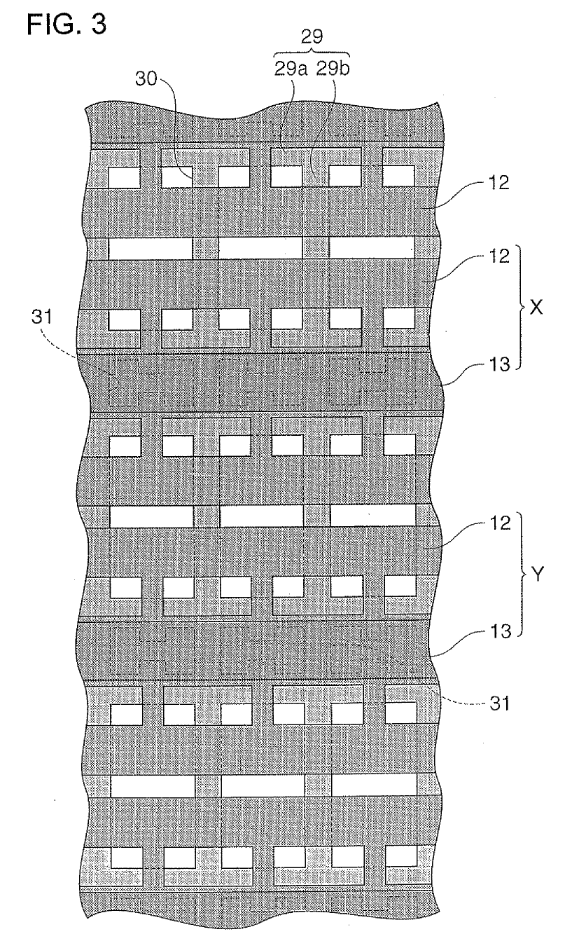

FIGS. 2 and 3 show a positional relationship between a partition structure and display electrodes of a first embodiment of a PDP in accordance with the present invention. In this PDP, first display electrodes X and second display electrodes Y serving as sustain discharge electrodes are disposed in an order of X·Y·X·Y . . . . Here, a gap between the display electrode X and the display electrode Y is formed into a display cell. This PDP is provided with a plurality of partitions 29 formed as a mesh shape by using a sand blasting method. Each partition 29 is configured by lateral wall sections 29a serving as first wall sections that extend in a line direction (a direction in which the display electrodes X, Y are formed) and longitudinal wall sections 29b serving as second wall sections that extend in a column direction (a direction that intersects with the direction in which the display electrodes X, Y are formed).

The partitions 29 are formed through processes in which, after a glass paste, made from a low-melting-point glass frit, a binder resin, a solvent and the like, has been applied onto the dielectric layer 24 and dried thereon, grinding grains are blasted onto the glass paste layer, with a grinding mask having apertures corresponding to a partition pattern being formed thereon, so that the glass paste layer, exposed to the mask apertures, is ground, and further fired. This firing process causes thermal shrinkage to the ground glass paste layer.

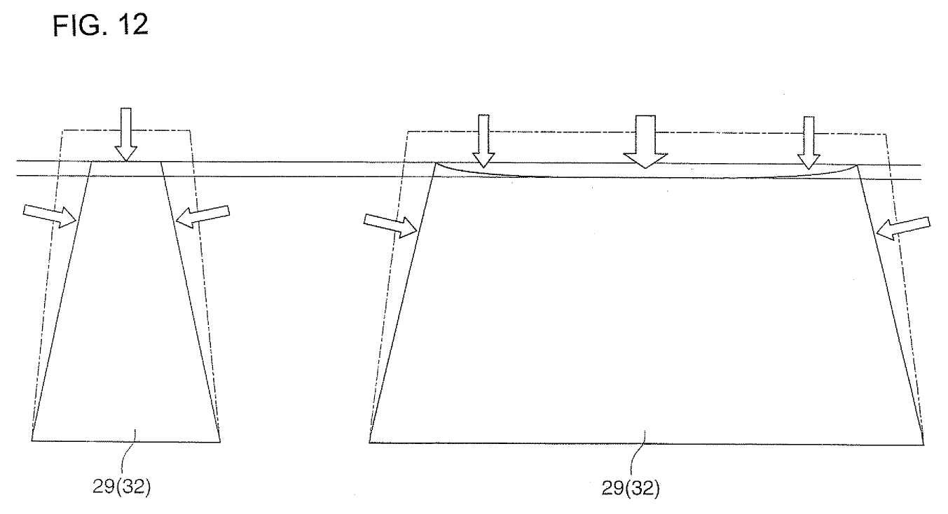

FIG. 12 shows an outline shape (dotted line) of the partitions 29 prior to the firing process and an outline shape (solid line) of the partitions 29 after the firing process. This figure indicates that the partitions 29 have different amounts of thermal shrinkage depending on respective portions (upper face portion, side face portion and the like).

In the display cells, the discharge space (discharge light-emitting region) 30 is divided by the partitions 29 made of the lateral wall sections 29a and the longitudinal wall sections 29b for each line and for each column. Moreover, in the partitions 29, in each portion between the lines that corresponds to a portion between the discharge light-emitting regions 30 placed side by side in the column direction, a non-discharge region 31 having a rectangular shape in its plane shape is formed so as to be surrounded by the longitudinal wall sections 29b and the lateral wall sections 29a.

Each of the display electrodes X, Y is configured by a transparent electrode 12 that extends in a horizontal direction in a manner so as to bridge over the adjacent cells in the column direction and a BUS electrode 13 having a high conductivity, and each BUS electrode 13 is disposed to be located at such a position as to be superposed on the gap between the lines.

When the non-discharge region 31 is disposed, in this manner, at the gap between the lines on which the BUS electrode 13 is superposed, since the dielectric constant of a discharge gas is about ⅛ of the dielectric constant of low-melting-point glass that is generally used as a material for partitions, it becomes possible to reduce an electrostatic capacity between the display electrodes X and Y on the mutually adjacent lines, and consequently suppress wasteful power consumption.

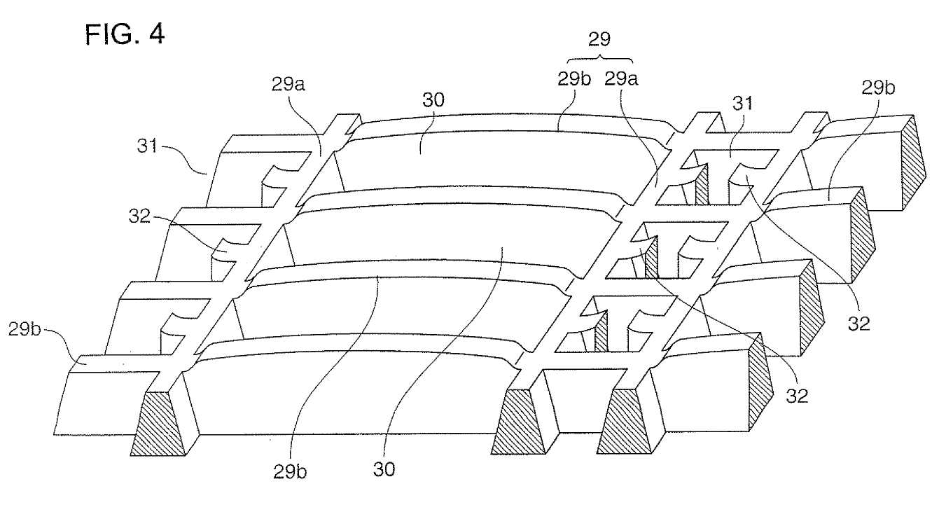

In the present embodiment, as shown in FIG. 2 and FIG. 4, auxiliary partitions 32 are installed in addition to the partitions 29. That is, in each of the non-discharge regions 31 located in a gap portion between lines, paired auxiliary partitions 32, 32 opposing to each other that protrude from the lateral wall sections 29a of partitions 29 toward an inside of each non-discharge region 31 are formed. The respective auxiliary partitions 32 are formed integrally with the partitions 29 by using the same material and the same forming method as those of the partitions 29.

The partitions 29 and the auxiliary partitions 32, 32 are formed in such a manner that, by utilizing a difference in the amounts of thermal shrinkage caused by different portions of each partition 29 (auxiliary partitions 32, 32) as shown in FIG. 12, each of the auxiliary partitions 32, 32 has a partial height higher than the lateral wall sections 29a and the longitudinal wall sections 29b of the partitions 29 that define the non-discharge regions 31 (see FIG. 4).

As shown in FIG. 4, the relationship of heights between the lateral wall sections 29a as well as the longitudinal wall sections 29b of the partitions 29 that surround each discharge light-emission region 30 and the auxiliary partitions 32, 32 of the non-discharge region 31 is explained as follows. That is, the upper face of each longitudinal wall section 29b is highest in its center portion and becomes gradually lower toward the respective end portions to have the lowest portion at an intersection with each lateral wall section 29a, which is equal to the height of the flat upper face of each lateral wall 29a. Moreover, the upper face of each of the auxiliary partitions 32 that respectively protrude toward the inside of the non-discharge region 31 from the lateral wall sections 29a of the partitions 29 has a protrusion base end having a height equal to the height of the flat upper face of each lateral wall section 29a, and becomes gradually higher toward its protrusion tip to have the highest portion at the protrusion tip.

By utilizing the difference in the amounts of thermal shrinkage, the partitions 29 and the auxiliary partitions 32, 32 are allowed to have such structures that a gap, which is formed by a height difference between the partitions 29 (lateral wall sections 29a and longitudinal wall sections 29b) of the non-discharge region 31 and the auxiliary partitions 32, 32, is utilized as a gas exhaust passage and/or an introduction passage of a discharge gas. Thus, it becomes possible to increase exhaust efficiency, and consequently to provide a high quality PDP with high reliability.

In the present embodiment, highest height of the upper face of the auxiliary partitions 32, 32 is made higher than that of the lateral wall sections 29a of the partitions 29 that define the non-discharge regions 31 by about 10 μm or more.

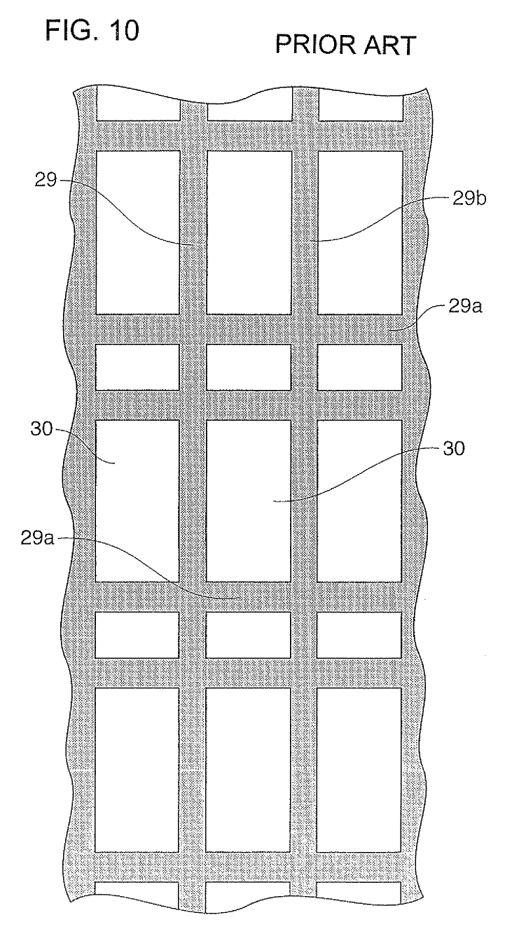

In the present embodiment, as well as in the conventional structure shown in FIG. 10, a height difference is caused due to a difference in the amounts of thermal shrinkage between the longitudinal wall sections 29b and the lateral wall sections 29a. Therefore, in the case when the highest height of the auxiliary partitions 32, 32 is made higher than the highest portion of the longitudinal wall sections 29b, the largest height difference is obtained, which is considered to be a preferable structure. However, when the highest height of the auxiliary partitions 32, 32 becomes too high in comparison with the highest height of the longitudinal wall sections 29b, a space is generated between the longitudinal wall sections 29b and the substrate 11 on the front face side, with a result that discharge interference in a horizontal direction occurs. Therefore, the height difference between the highest height of the auxiliary partitions 32, 32 and the highest height of the longitudinal wall sections 29b is preferably set to not more than 10 μm.

### SECOND EMBODIMENT

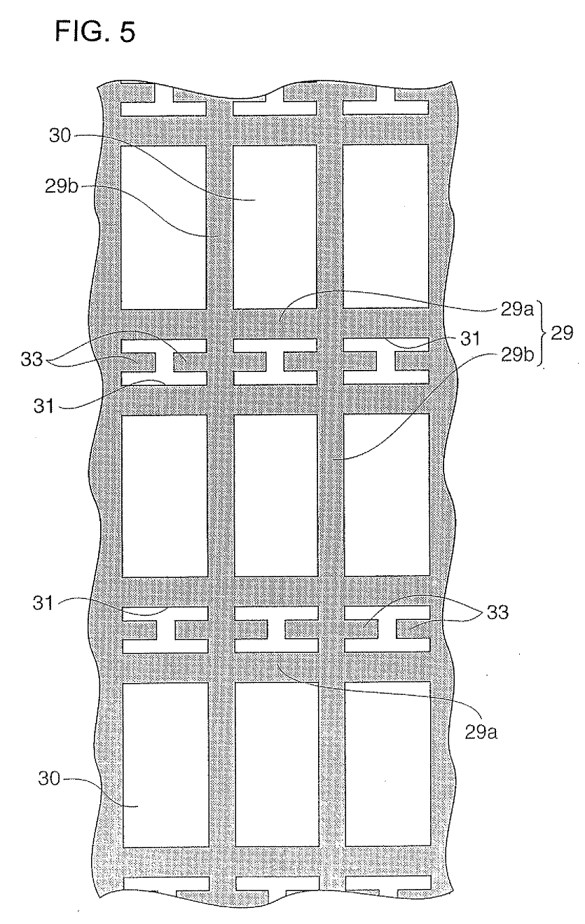

FIG. 5 is a plan view that shows partitions and auxiliary partitions of a second embodiment of a PDP in accordance with the present invention. That is, in the second embodiment, paired auxiliary partitions 33, 33 opposing to each other are allowed to protrude toward the inside of each non-discharge region 31 from the longitudinal wall sections 29b of partitions 29 that face the non-discharge region 31.

Here, in the first embodiment and the second embodiment, two auxiliary partitions 32, 32 (33, 33) are formed for each single non-discharge region 31. However, the number of the auxiliary partitions to be formed in each non-discharge region 31 may be set to one, or may be set to three or more.

### THIRD EMBODIMENT

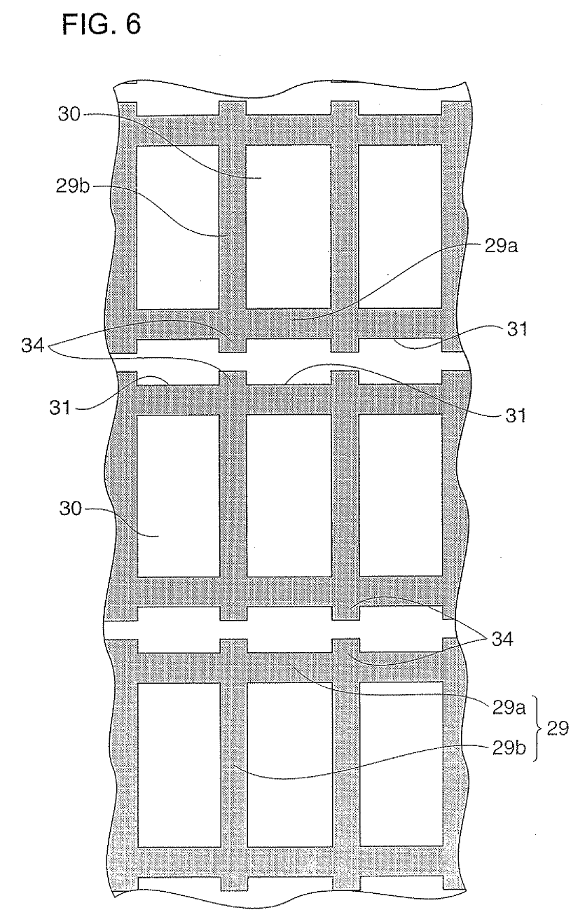

FIG. 6 is a plan view that shows partitions and auxiliary partitions of a third embodiment of a PDP in accordance with the present invention. The third embodiment differs from the first embodiment in that a plurality of non-discharge regions 31, 31, 31 corresponding to gap portions between adjacent lines in the line direction are allowed to communicate with one another, and in that the auxiliary partitions 34, 34 opposing to each other are allowed to protrude from the lateral wall sections 29a toward the inside of each of the non-discharge regions 31, 31 that communicate with one another, at each intersection point between the longitudinal wall sections 29b and the lateral wall sections 29a.

With this arrangement, not only the gas exhaust passage formed by the height difference generated between the lateral wall section 29a and the auxiliary partition 34 of each of the partitions 29, but also a gas exhaust passage that extends in a lateral direction (in a direction crossing the longitudinal wall sections 29b) is formed at the gap portion between the lines; thus, it becomes possible to achieve higher exhaust efficiency.

In the third embodiment shown in FIG. 6, the auxiliary partitions 34, 34 are allowed to protrude from the lateral wall sections 29a toward the inside of each of the non-discharge regions 31, 31 that communicate with one another, at each intersection point between the longitudinal wall sections 29b and the lateral wall sections 29a. However, the auxiliary partitions may be allowed to protrude from the lateral wall sections toward the inside of each of a plurality of non-discharge regions that communicate with one another at a portion other than each intersection point between the longitudinal wall sections 29b and the lateral wall sections 29a.

### FOURTH EMBODIMENT

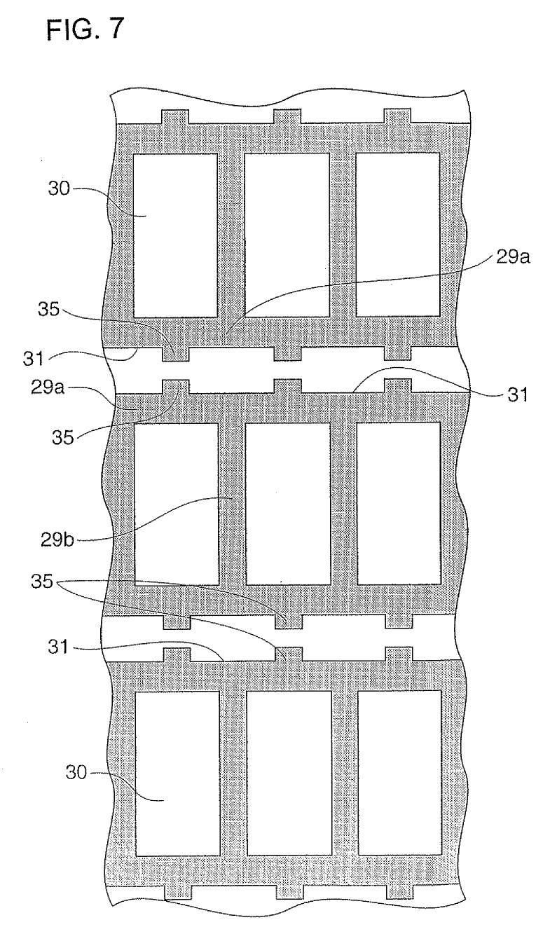

FIG. 7 is a plan view that shows partitions and auxiliary partitions of a fourth embodiment of a PDP in accordance with the present invention. The fourth embodiment is provided with a structure in which auxiliary partitions 35, 35 opposing to each other are allowed to protrude from the lateral wall sections 29a toward the inside of each of a plurality of non-discharge regions 31 that communicate with one another.

In a case of a conventional structure shown in FIG. 10 in which no auxiliary partitions are formed, a problem arises in which, upon firing the partitions 29, the lateral wall sections 29a are pulled by the longitudinal wall sections 29b to fall into the discharge light-emission region 30 side. In contrast, in the fourth embodiment, since the auxiliary partitions 35 are formed so that it is possible to obtain an effect for preventing the lateral wall sections 29a from falling down, in addition to the above-mentioned effect for ensuring the gas exhaust passage.

### FIFTH EMBODIMENT

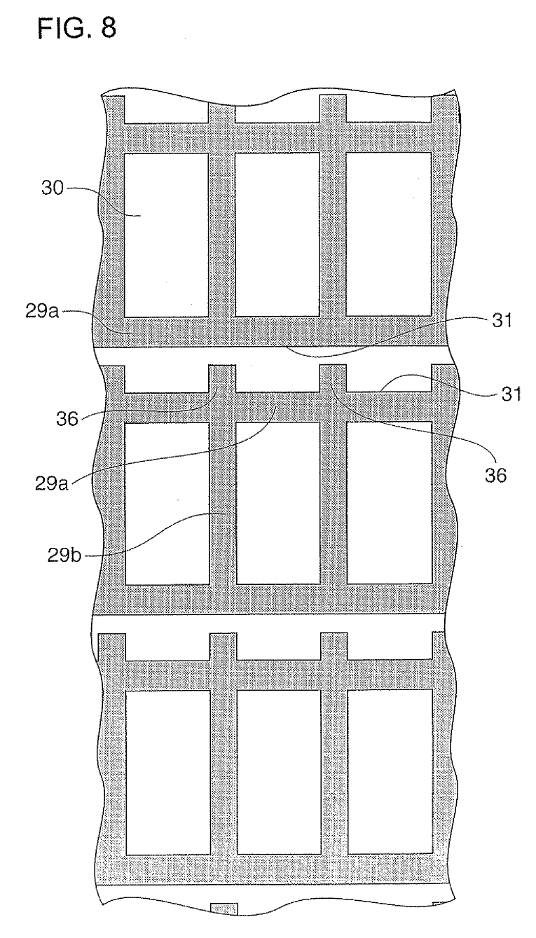

FIG. 8 is a plan view that shows partitions and auxiliary partitions of a fifth embodiment of a PDP in accordance with the present invention. The fifth embodiment is provided with a structure in which an auxiliary partition 36 is allowed to protrude from only one of the two lateral wall sections 29a, 29a located at a gap portion between lines toward the inside of each of a plurality of non-discharge regions 31 that communicate with one another.

### SIXTH EMBODIMENT

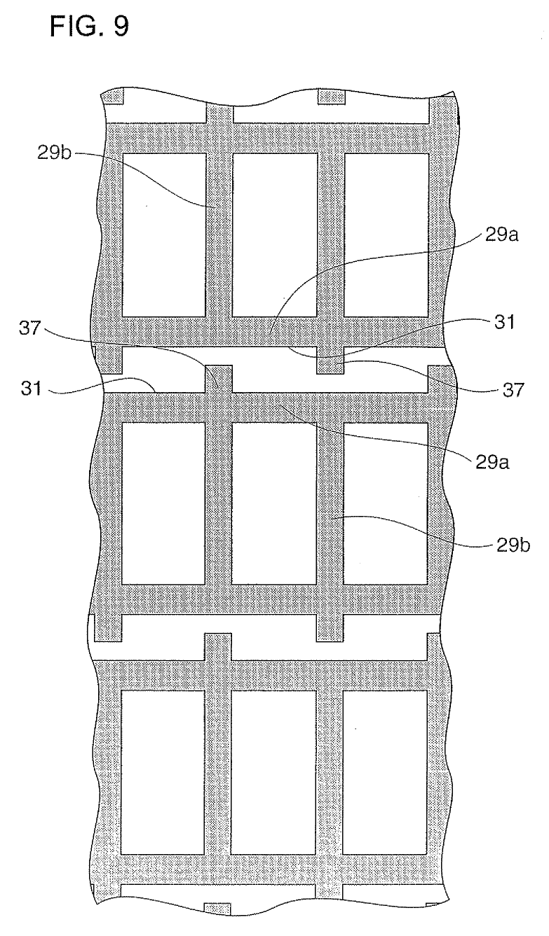

FIG. 9 is a plan view that shows partitions and auxiliary partitions of a sixth embodiment of a PDP in accordance with the present invention. The sixth embodiment is provided with a structure in which auxiliary partitions 37 are allowed to protrude from the lateral wall sections 29a toward the inside of each of a plurality of non-discharge regions 31 that communicate with one another, in a manner so as to be alternately shifted from each other, at each intersection point between the longitudinal wall sections 29b and the lateral wall sections 29a.

As shown in the fifth embodiment and the sixth embodiment, by allowing the auxiliary partition 36 to protrude from only one of the lateral wall sections 29a, or by allowing the auxiliary partitions 37 to protrude in a manner so as to be alternately shifted from each other, a width of a gap portion between the lines can be narrowed in comparison with the structure in which the auxiliary partitions are allowed to protrude from both of the lateral wall sections 29a. As a result, since the area of the discharge light-emission region can be enlarged, the light-emitting efficiency and luminance of the cells can be enhanced.

1. A plasma display panel comprising:
a pair of substrates for forming a discharge space;
a plurality of display electrodes that extend in a predetermined direction and a plurality of address electrodes that extend in a direction intersecting with said display electrodes, said display electrodes and said address electrodes being placed between said paired substrates;
display lines produced by surface discharge that are provided between said display electrodes adjacent to each other, with a discharge light-emission region being set at an intersection between each display line and each address electrode; and
partitions for defining said discharge light-emission regions for each line and for each column, by a first wall section that extends in a direction along which said display electrodes are formed and a second wall section that extends in a direction along which said address electrodes are formed,
wherein a non-discharge region is formed between said display lines adjacent to each other, and an auxiliary partition is formed on the first wall section or the second wall section of said partitions that divide said non-discharge region so as to protrude into said non-discharge region therefrom, with said auxiliary partition being formed by firing a material having a thermal shrinkability, so that upon firing, since an amount of thermal shrinkage in a height direction becomes uneven, a height of an upper face of said auxiliary partition is partially made higher than the height of the upper face of said first wall section and the height of the upper face of said second wall section of each of said partitions that divide said non-discharge region.

2. The plasma display panel according to claim 1, wherein said non-discharge region is prepared as a plurality of non-discharge regions that are allowed to communicate with one another.

3. The plasma display panel according to claim 1 or 2, wherein said auxiliary partition is allowed to protrude from said second wall section.

4. The plasma display panel according to claim 1 or 2, wherein said auxiliary partition is allowed to protrude from said first wall section.

5. The plasma display panel according to claim 2, wherein said auxiliary partition is allowed to protrude from said first wall section at an intersection point between said second wall section and said first wall section.

6. The plasma display panel according to claim 1 or 2, wherein a height difference between a highest height of the upper face of said auxiliary partition and a lowest height of the upper face of said first wall section or said second wall section of each of said partitions that divide said non-discharge region is not less than 10 μm.

7. The plasma display panel according to claim 1 or 2, wherein a height difference between a highest height of the upper face of said auxiliary partition and the highest height of the second wall section of each of said partitions that divide said non-discharge region is not more than 10 μm.
